(19) United States
(12) Patent Application Publication
(10) Pub. No.: US 2005/0289031 A1
(43) Pub. Date: Dec. 29, 2005

(54) Computerized method of processing investment data and associated system

(76) Inventor: David H. Campbell, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/878,763

(22) Filed: Jun. 28, 2004

(51) Int. Cl. G06F 17/60

(52) U.S. Cl. 705/35

(57) ABSTRACT

A computerized method of processing investment data includes providing at least one data object interface having a plurality of data objects, introducing into the data object interface investment data of different formats from a plurality of external sources, processing the investment data by the data object interface to create a uniform format and delivering the processed investment data to a database supported by a server for storage therein and retrieval therefrom. The data objects may be reused and reassembled to establish different processing sequences for the external source investment data of different formats. A corresponding computerized system for processing investment data is provided.

### BACKGROUND OF THE INVENTION

1. Field of the Invention

The present invention relates to an improved method and an associated computerized system for facilitating the efficient processing of externally delivered investment data which may be received in a wide variety of formats and transforming the same into a uniform format for delivery to a database and supporting server and more specifically, it relates to the use of a plurality of data objects which may be assembled in various functional ways so as to be structured to process the externally received data into a common format.

2. Description of the Prior Art

It has long been known to employ computers to receive data, process the same within a computer and store the same for retrieval from a database.

With the high volume of investment transactions, it has long been known to make advantageous use of a computerized system in the receipt, processing, storing and outputting of various types of investment data in various forms. See, for example, U.S. Pat. Nos. 5,749,077 and 5,893,079.

One of the problems which has occurred involves the fact that investment data delivered to a computer system from a wide variety of sources may be in different formats and representations thereby making it difficult for a computerized system to readily introduce such data into the server processing and database storage portions of the system.

There remains, therefore, a real and substantial need for an effective automated system which can accurately and flexibly process externally delivered investment data which may be in different formats and presentations.

### SUMMARY OF THE INVENTION

The present invention has met the hereinbefore described needs.

In a preferred method of the invention, at least one data object interface has a plurality of data objects. Externally delivered investment data which may come from different sources and have different formats is delivered to the data object interface and is processed therein to establish a common or uniform format of the data which in turn is delivered to a server for storage in and retrieval from a database. By effecting this conversion, the database and server will receive data in a common form regardless of the plurality of forms in which it is delivered to the data object interface. The interfaces are created employing reusable data objects which may be selected as needed for a particular interface so as to effectively process each of the externally delivered investment data components regardless of source or nature. The individual data object interfaces may be restructured as needed to accommodate the processing of a particular format or presentation of investment data.

The computerized system of the present invention includes at least one data object interface. At least one data object interface receives and processes externally delivered investment data and converts the same to the same or common format which is delivered through the server to the database which it supports.

It is an object of the present invention to provide a computerized method and associated system for receiving from external non-user sources investment data in various formats and presentations and employing data object interfaces to convert the same to a common data format.

It is another object of the present invention to provide such a system wherein the data objects may be custom-assembled in various sequences so as to achieve the objective of conversion of the varying external investment data to be in the desired uniform format.

It is a further object of the present invention to provide support people with an opportunity to customize the processing of the external investment data without the need to after the underlying software.

It is a further object of the present invention to provide such a method and system which is structured to receive a wide variety of investment data from a large number of sources and efficiently convert the same to the desired common or standard format for delivery to the server and database.

These and other objects of the invention will be fully understood from the following detailed description of the invention on reference to the illustrations appended hereto.

### BRIEF DESCRIPTION OF THE DRAWINGS

FIG. 1 is a schematic illustration of the method and system of the present invention as employed in receiving investment data from the first through nth source.

FIG. 2 is a schematic diagram illustrating a portion of the sequence of processing of the present invention.

FIG. 3 is a schematic illustration involving the flow of an example of a transaction.

FIG. 4 illustrates schematically a plurality of object interfaces as employable in the present invention.

FIG. 5 illustrates a type of client hierarchy processing employable in the present invention.

FIG. 6 illustrates another form of client hierarchy processing of the present invention.

### DESCRIPTION OF THE PREFERRED EMBODIMENTS

As employed herein, the term “data object” means an interchangeable software logic component usable with other data objects in a data object interface to perform essentially the same function in different ways.

As employed herein, “data object interface” means a functional interface for conversion of external investment data of different formats into a common format with each data object interface including at least two data objects. The data object interface may be composed of a group of data object interfaces.

As employed herein, the term “investments” shall expressly include, but not be limited to, mutual funds, common and preferred shares of stocks, whether listed on an exchange or not, high-yield corporate bonds and high-grade corporate bonds, municipal bonds, United States bills, notes and bonds, mortgage-related investments and short-term securities such as commercial paper, bankers acceptances, re-purchase agreements and supporting currencies.

As employed herein, the term “investment data” means data dealing with investments or organizations or individuals who are involved in investments and shall expressly include, but not be limited to, those occupationally involved as well as their customers and clients and shall expressly include information relating to brokers, dealers, clients, main offices, branch offices, addresses, telephone numbers, identify of individuals as well as titles and responsibilities and similar access and identifying information.

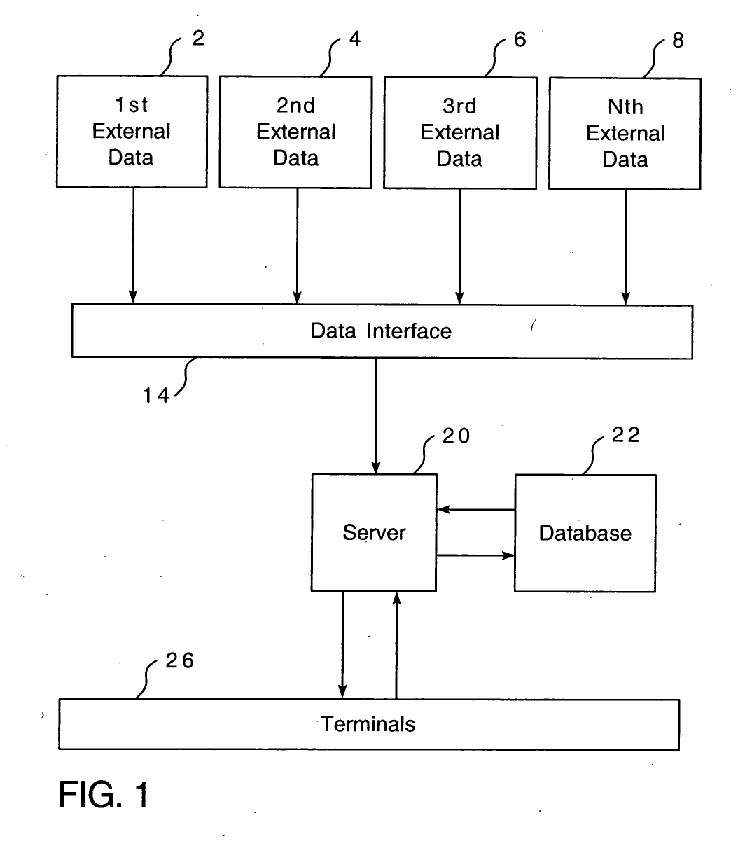

Referring in greater detail to FIG. 1, there is shown schematically a method and associated apparatus of the present invention. Representing the diverse sources of external non-user input data are blocks 2, 4, 6, 8 which represent the 1st, 2nd and 3rd external data sources up through the nth data source. It will be appreciated that the system can accommodate any number of sources and, as will be described hereinafter, even if the sources provide data in different formats, appearances and non-common form in respect of the other external sources.

The external investment data 2, 4, 6, 8 is received in the data object interface 14 and is processed therein so as to convert it into the identical format representation which for convenience of reference herein will be referred to as a “common format”. The data thus converted is delivered to the server 20 which in turn presents it to the database 22 wherein it is stored in retrievable fashion in the appropriate data storage tables.

When a user at one of the terminals 26 wishes to access the data, this is accomplished through server 20 which supports database 22.

In this manner, the computerized conversion of data at the data interface 14 permits rapid, efficient and accurate conversion of the diverse external investment data entering interface 14 into a usable common form.

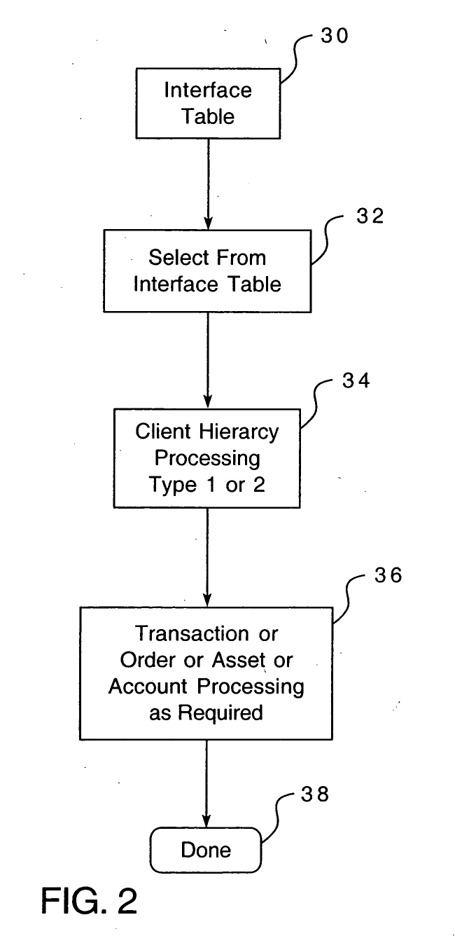

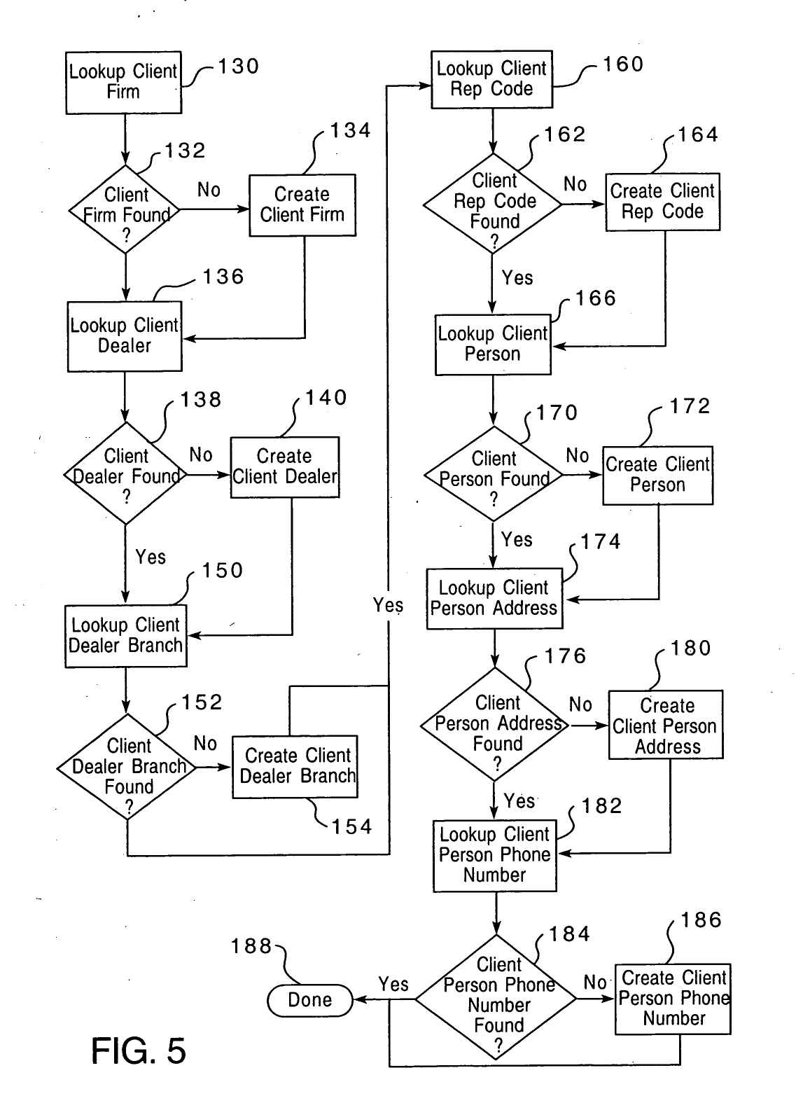

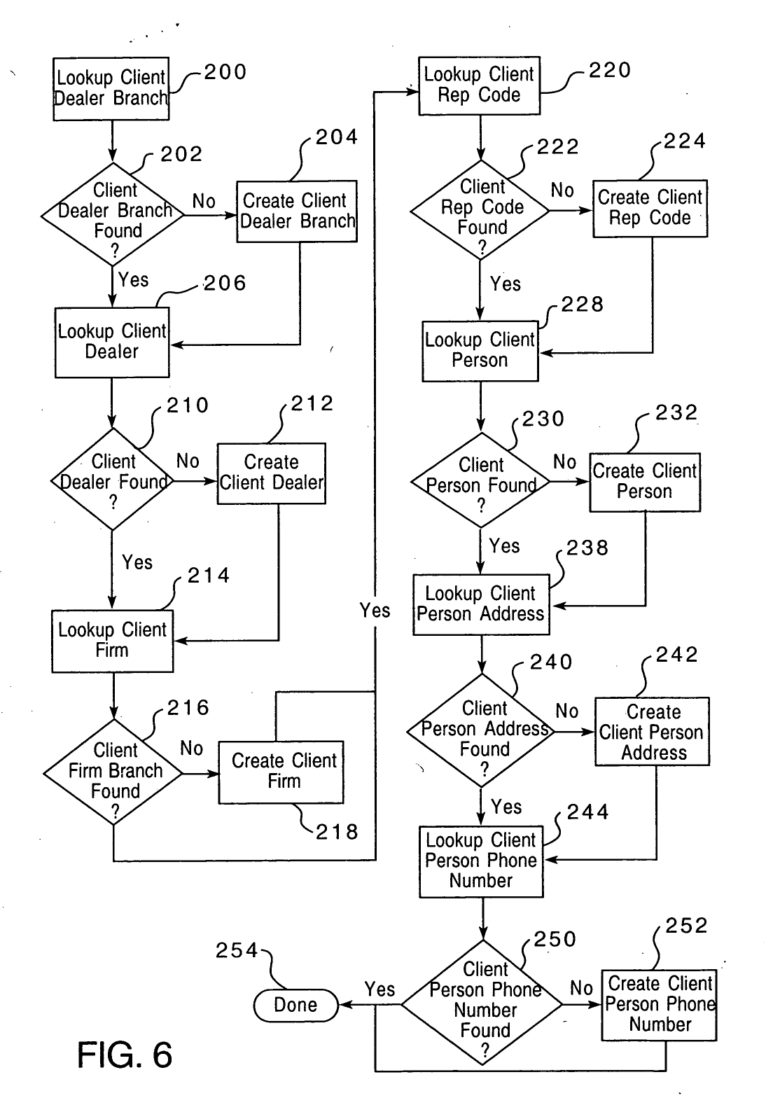

Referring to FIG. 2, the interface table 30 permits one to select investment data from the interface table 32 to create client hierarchy processing of Type 1 or Type 2 which will be discussed hereinafter in connection with FIGS. 5 and 6. Further processing 36 is accomplished prior to termination 38 of that cycle of operation.

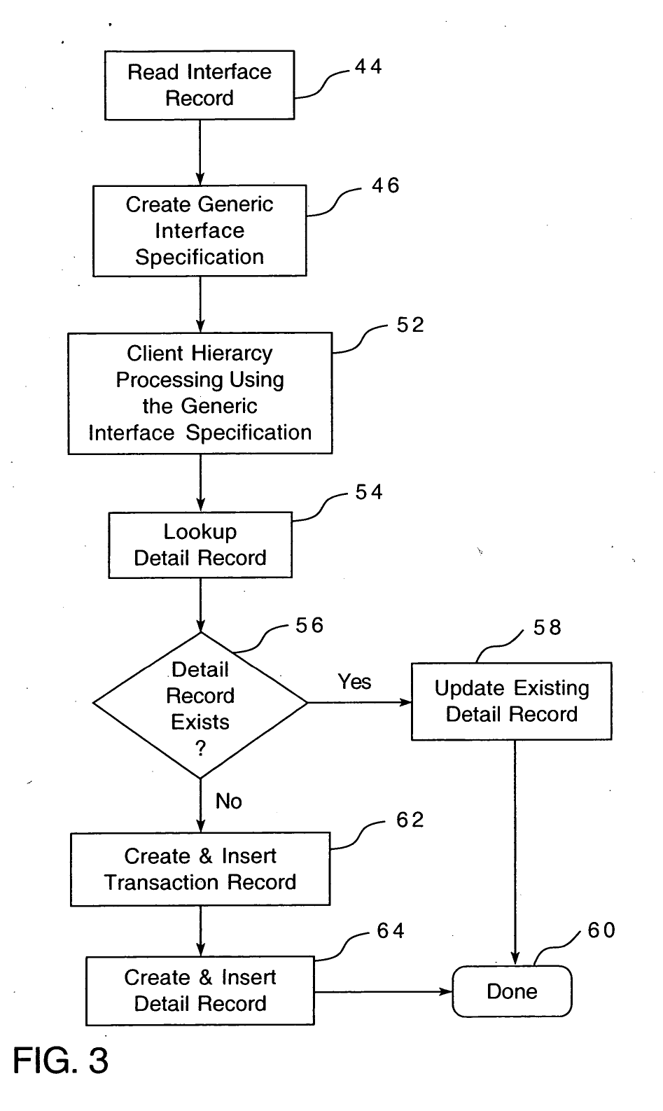

Referring to FIG. 3, the interface investment data is read 44 after which a generic interface specification 46 is created in common format followed by client hierarchy processing, employing the generic interface specification 52. This is followed by a lookup of the detail record 54 and the question 56 as to whether the detail record exists. If it does, the detailed record is updated 58 and the cycle of operation 60 is at an end. If it does not exist, one may create and insert a transaction record 62 followed by creating and inserting the detail record 64 after which the process is done 60. This is an example of transaction processing suitable for use in connection with many types of transactions such as, for example, mutual fund purchase and redemptions.

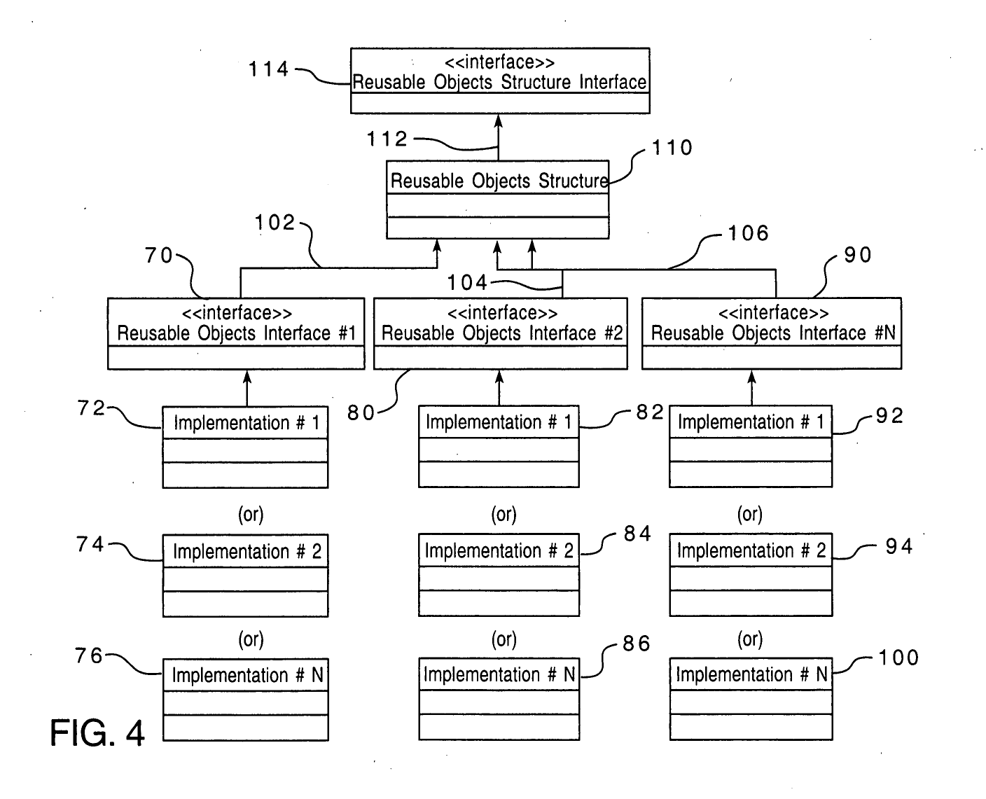

Referring to FIG. 4, details regarding the flexibility of modification of the data objects and assembly thereof to create each desired data object interface and the overall resulting interface will be considered. In the preferred form, the interface contains all of the logic needed to convert the investment data.

Referring first to the reusable object interface #1, 70 there may be several different implementations depending upon the anticipated nature and format of the external investment data that will be delivered to the overall interface. For example, a first group of data objects 72 may be functionally and operationally associated with object interface #1, 70 to serve to convert a specific type of investment data into the desired common format. Alternatively, implementation 74 which is implementation #2 may be operatively associated with 70 to function in conversion. Also, implementation #N, 76 may be employed. It will be appreciated that by selecting from what might be deemed conceptually a box of logic parts, one may as to object interface #1, 70 provide various groupings of data objects to facilitate receipt of external investment data from a specific source being converted to the desired common form for delivery to the server 20 and database 22 (FIG. 1). It will be appreciated similarly, a second object interface #2, 80 may be operatively associated with implementation #1, 82 or implementation #2, 84 or implementation #N, 86. Also, with respect to object interface #N, 90, it may be employed with implementation #1, 92 or implementation #2, 94 or implementation #N, 100.

It will be appreciated that the object interfaces #1, #2 through #N, 70, 80, 90, each serves a role in what may be considered the overall data object interface in processing specific types of incoming external investment data so as to convert it to the common desired format. It will also be noted that these are reusable and can function in the next cycle of the operation. Further, the data objects which may be considered the building blocks of the various implementations 72, 74, 76, 82, 84, 86, 92, 94, 100 may be moved to other implementations to create custom implementations suitable for a specific processing purpose. The data object arrangements involve an analysis of the requirements for processing the external investment data to be received and knowledge of the available data objects to be assembled to perform the desired conversion. This is accomplished automatically within the suitably programmed interface.

The respective outputs 102, 104, 106 from the usable object interface #1, 72, reusable object interface #2, 82 and reusable interface #N, 92 are introduced into the object structure 110 which may be considered in a broad sense the feeder of the converted investment data which is delivered 112 to the reusable object structure interface 114 from which the investment data in common format will be delivered to the server 20 and database 22 (FIG. 1).

It will be appreciated that the various data objects are swappable from implementation to implementation. It will also be appreciated that the data object interface may read the received external investment data information in a variety of formats and encodings including fixed-length and comma-separated variables. The data object interface facilitates more flexibly configuring the object interfaces. This is preferably effected through a configuration file which may be written in extensible mark-up language.

The data object interfaces have a capability of reading files containing records of different formats within the same physical file. The interface 14 may have dynamic data caching means in order to improve efficiency of data processing.

The data object interface has the capability of detecting missing, but essential data elements received in the external investment data. It also has the ability to substitute default values from missing, but essential data elements in the external investment data.

If it is desired to set certain values to be held constant through the data processing in the data object interface, these settings may be achieved through authorized users and support personnel without altering the underlying software.

To the extent to which there may unusable or invalid data elements received in the external investment data, the data object interface can detect the same as well as altering the same to make them usable in numerous instances.

The data object interface also has the capability of detecting data values that would cause incorrect processing such as missing or null values or values that are too long to match existing data and if that is done, it may determine to terminate that cycle of the process and to begin again.

In the embodiment of client hierarchy processing shown in FIG. 5 which for convenience of reference has been referred to Type 1, one initially looks up a client firm 130. The question then raised is whether the client firm was found 132. If it was not, one has the opportunity to create the client firm 134 and if it is, one is enabled to lookup client dealer 136. The next question is whether the client dealer is found 138. If not, one may create a client dealer 140, and if it is, one may look up the client dealer branch 150. The following question is whether the client dealer branch has been found 152. If not, one may create a client dealer branch 154 and if it is found, one may look up the client representative code 160. The query then becomes whether the client representative code has been found 162. If not, the client representative code may be created 164 and if it is found, one may look up the client person 166. At that point, the query becomes whether the client person has been found 170. If not, one may create a client person 172. If it has been found, one may look up the client person address 174 with the query becoming whether the address has been found 176. If not, one may create a client person address 180 and if it has been found, one may look up the client person telephone number 182. If the client person telephone number is not found 184, one may create a client person phone number 186 and if it has, one has completed the chore 188. It will be appreciated from FIG. 5, that through following the hierarchical process, one may sequentially obtain the desired information and if an element of the information has not been found, it may be entered. It will be appreciated that the lookups occur in the database 22 (FIG. 1) where the data is stored. The database 22 resides on server 20 or it may have a separate server.

Referring to FIG. 6, a client hierarchy process identified for convenience of reference as Type 2 will be considered. This is more appropriate for a different level of investment activity than that of FIG. 5. It will be noted that the initial steps in FIG. 5 involved client firm and client dealer with the third step involving client dealer branch. In FIG. 6, the first step is looking up client dealer branch 200 and the query of whether it exists 202. If the answer is negative 204, one may create the client dealer branch identification and, if it does exist, one may look up the client dealer 206. The next inquiry is whether the client dealer has been found 210. If the answer is “no” 212, one may create the client dealer information and if the answer is “yes”, one may look up the client firm 214 leading to the query of whether the client firm branch has been found 216. If the answer to that query is negative, one may create the client firm 218 and if it is “yes”, one may look up the client representative code 220, with the next query being whether the client representative code has been found 222. If the answer is “no” 224, one may create the client representative code and if it is “yes”, one may look-up the client person 228. Next the query is whether the client person is found 230. If the answer is “no”, 232, one may create the client person information. If it is “yes” 238, one may look up the client person address with the next query being whether the client person address was found 240. If the answer is “no” 242, one may create the client person address and if it is “yes”, one may look up the client person phone number 244. The next query is whether the client person phone number has been found 250. If the answer is “no” 252, one may create it and if it is “yes”, one has completed the cycle 254.

It will be appreciated that a great deal of investment data involves orders (no money received yet), purchases (money received), sales, asset value, asset positions, commission, attribution as well as processing investment data for others, such as firms, branches, representatives (brokers) and accounts (shareholders). The external investment data may readily be received from a wide variety of sources in various formats and representations and through the present data object interface create a common format which may be automatically processed through the server 20 and database 22 to provide meaningful information in rapid and accurate fashion. The user may then access the information in a hierarchical manner with the freedom to alter the information or to provide missing information if desired.

Whereas particular embodiments of the invention have been described herein for purposes of illustration, it will be evident to those skilled in the art the numerous variations of the details may be made without departing from the invention as set forth in the appended claims.

1. A computerized method of processing investment data comprising
providing at least one data object interface having a plurality of data objects operatively associated with each other,
introducing into said data object interface investment data of different formats from external sources,
processing said invention data that was received by said data object interface into a common format, and
delivering said processed investment data to a database for storage therein and retrieval therefrom.

2. The computerized method of claim 1 including
subsequently reusing at least some of said data objects in practicing said method.

3. The computerized method of claim 1 including
creating new data object interfaces by interchanging data objects from one data object interface to another.

4. The computerized method of claim 1 including
employing said method to process a plurality of types of data from external sources in a plurality of formats.

5. The computerized method of claim 4 including
said format including one selected from the group consisting of fixed-length fields and comma-separated variables.

6. The computerized method of claim 1 including
processing a portion of said individual data in a server which receives the investment data from said data object interface.

7. The computerized method of claim 6 including
employing said server to support said database.

8. The computerized method of claim 1 including
employing a configuration file to configure said data object interface.

9. The computerized method of claim 1 including
said data object interface having a reading file containing records of different formats within the same physical files.

10. The computerized method of claim 9 including
said data object interface logically recording fields within a physical file in order to facilitate processing of external investment data.

11. The computerized method of claim 9 including
employing extensible mark-up language in reading said external source investment data.

12. The computerized method of claim 1 including
said processing of said external investment data converting said data to the format employed in said database.

13. The computerized method of claim 1 including
said interface detecting missing but essential investment data elements received in said external source investment data.

14. The computerized method of claim 9 including
said interface being structured to substitute default values for said missing but essential data elements.

15. The computerized method of claim 1 including
said data object interface being structured to permit users to establish values to be held constant during data processing without requiring modification of the underlying software.

16. The computerized method of claim 1 including
said data object interface detecting the presence of unusable or invalid data elements received in said external investment data.

17. The computerized method of claim 16 including
said data object interface converting said unusable or invalid data elements to render them usable.

18. The computerized method of claim 1 including
detecting by said data object interface data values received in said external investment data that would contribute to incorrect processing.

19. The computerized method of claim 1 including
having in said unusable or invalid data elements missing or null values and values too long to match existing data.

20. The computerized method of claim 1 including
when said data object interface determines that incorrect data processing has occurred returning said process to a stage before said incorrect processing was initiated.

21. The computerized method of claim 1 including
employing a plurality of said data object interfaces.

22. A computerized system for processing investment data comprising
at least one data object interface for receiving and processing from external sources investment data in a plurality of formats,
said data object interface having a plurality of data objects structured to convert investment data of said different formats into a common format,
a server in communication with said data object interface for receiving said processed investment data therefrom, and
a server-supported database supported for receiving and storing said processed investment data.

23. The computerized processing system of claim 22 including
said data object interface being structured to reconfigure said data objects.

24. The computerized processing system of claim 22 including
said data objects being structured to be reused.

25. The computerized processing system of claim 22 including
said data objects being interchangeable to create new data object interfaces.

26. The computerized processing system of claim 22 including
said data object interface including the capability of creating a data format selected from the group consisting of fixed-length fields and comma-separated variables.

27. The computerized processing system of claim 22 including
employing a configuration file to configure said data object interface.

28. The computerized processing system of claim 22 including
said data object interface being structured to logically reorder fields within a physical file in order to facilitate processing of said external investment data.

29. The computerized processing system of claim 22 including
said data object interface being structured to employ extensible marking language in reading said external source investment data.

30. The computerized processing system of claim 22 including
said data object interface converting said external source investment data to the format employed in said database.

31. The computerized processing system of claim 22 including
said data object interface being structured to detect missing but essential investment data elements received in said externally delivered investment data.

32. The computerized processing system of claim 31 including
said data object interface being structured to substitute default values for said missing but essential data elements.

33. The computerized processing system of claim 22 including
said data object interface being structured to permit users to establish values to be held constant during data processing without requiring modification of the underlying software.

34. The computerized processing system of claim 22 including
said data object interface being structured to detect the presence of unusable or invalid data elements received in said external investment data.

35. The computerized processing system of claim 34 including
said data object interface being structured to convert said unusable or invalid data elements to render them usable.

36. The computerized processing system of claim 22 including
said data object interface being structured to detect by said data object interface data values received in said external investment data that would contribute to incorrect processing.

37. The computerized processing system of claim 35 including
said data object interface being structured to process said unusable or invalid data elements in the form of missing or null values and values too long to match existing data.

38. The computerized processing system of claim 22 including
said data object interface being structured when said data object interface determines that incorrect data processing has occurred returning said process to a stage before said incorrect processing was initiated.

39. The computerized processing system of claim 22 including
said system having a plurality of said data object interfaces.
